(19) United States
(12) Patent Application Publication
(10) Pub. No.: US 2018/0281934 A1
(43) Pub. Date: Oct. 4, 2018

(54) Front landing gear of reduced height and aircraft, in particular a flying wing, equipped with such a front landing gear

(71) Applicant: Airbus Operations SAS, TOULOUSE (FR)

(72) Inventors: Bernard GUERING, MONTRABE (FR); Laurent SAINT-MARC, MONTAIGUT SUR SAVE (FR)

(21) Appl. No.: 15/939,869

(22) Filed: Mar. 29, 2018

(30) Foreign Application Priority Data
Mar. 31, 2017 (FR) 1752816

(51) Int. Cl. B64C 25/12; B64C 25/34; B64C 39/10

(52) U.S. Cl. CPC B64C 25/12; B64C 2025/125; B64C 39/10; B64C 25/34

(57) ABSTRACT

A front landing gear comprising an undercarriage and a landing gear bay, the undercarriage including a single wheel, a landing gear strut and a stay rod, the undercarriage being movable between a retracted position in which it is stowed inside the landing gear bay and a deployed position in which it extends mainly outside the landing gear bay and the aircraft, the wheel then extending in a median longitudinal plane of the aircraft. The landing gear strut is laterally offset, extending in a plane strictly parallel to the plane of the wheel. The landing gear strut is articulated about a longitudinal axis pivot connection such that, when the undercarriage is moved between its retracted and deployed positions, the landing gear strut moves in a transverse plane. The front landing gear is particularly suitable for an aircraft of flying wing type.

### CROSS-REFERENCES TO RELATED APPLICATIONS

This application claims the benefit of the French patent application No. 1752816 filed on Mar. 31, 2017, the entire disclosures of which are incorporated herein by way of reference.

### BACKGROUND OF THE INVENTION

The present invention concerns a front landing gear assembly for an aircraft, such an assembly comprising, on the one hand, an undercarriage, usually with one or two wheels carried by a landing gear strut, and, on the other hand, a landing gear bay enabling the undercarriage to be accommodated. The front landing gear assembly (also more simply termed the front landing gear hereinafter) in accordance with the invention is particularly suitable for a flying wing type aircraft. The invention also concerns an aircraft, in particular a flying wing, equipped with a front landing gear according to the invention.

The following three characteristic orthogonal axes are usually used to describe an aircraft: a longitudinal axis X or roll axis extending from the nose of the aircraft to the tail of the aircraft; a transverse axis Y or pitch axis of the aircraft that connects the ends of the wings of the aircraft; and a vertical axis Z or yaw axis that, when the aircraft is on the ground, corresponds to the direction of terrestrial gravity. Throughout the description, the aircraft according to the invention (and the same goes for a prior art aircraft) is observed in a position in which its longitudinal and transverse axes are substantially horizontal, that is to say, in its position when it is on the ground.

The front undercarriage of an aircraft is conventionally retractable and, in the retracted position, is accommodated in a box structure, also termed a landing gear bay, located in the nose portion of the aircraft. The front landing gear bay most often takes the form of a substantially parallelepipedal block of elongate general shape. An opening is provided in a lower wall of the bay to enable the undercarriage to leave it and to enter it.

In an aircraft with a fuselage, such as a classic passenger transport aircraft, the volume available inside the fuselage is divided into two zones separated by a floor: an upper zone accommodating a cockpit for the crew and a cabin to receive passengers, and a lower zone accommodating a hold, the greater part of which (cargo hold) is used to transport merchandise, and a front part of which (technical hold) is reserved for the integration of systems. In such an aircraft with a fuselage, the front landing gear bay is generally accommodated under the floor, in the technical hold.

The integration of the front landing gear bay in a flying wing poses problems. Indeed, a flying wing comprises only one level; it has no hold. Moreover, a flying wing must have a thickness (vertical dimension) which is as small as possible to compensate a horizontal surface area greater than that of a classic aircraft with a fuselage. Simple integration of a conventional front landing gear bay, the overall size of which is large, in the nose portion of a flying wing is therefore reflected in a considerable reduction of the volume allocated to the cockpit and to the principal functions of the aircraft. It is consequently necessary to develop a specific front landing gear architecture for flying wings.

It is to be noted that the integration of the main landing gear does not cause the same problem, because the main landing gear can be offset laterally relative to the passenger cabin, toward the wings; this is not the case for the front landing gear which has to remain in a central position and competes with functions located at the front of the aircraft (cockpit, systems, cabin service equipment, known as “galleys,” etc.).

### SUMMARY OF THE INVENTION

The invention aims to provide a front landing gear (undercarriage and landing gear bay) specifically adapted to suit flying wings, that is to say, a front landing gear of great compactness and, in particular, of small heightwise bulk.

To this end, the invention proposes a front landing gear and an aircraft equipped with such a front landing gear, the latter comprising an undercarriage and a landing gear bay, the undercarriage including a single wheel and a landing gear strut, the undercarriage being movable between a retracted position in which it is stowed inside the landing gear bay and a deployed position in which it extends mainly outside the landing gear bay and the aircraft, the wheel then extending in a median longitudinal plane of the aircraft.

The front landing gear and the aircraft according to the invention are characterized in that:

the landing great strut is offset laterally, extending in a plane strictly parallel to the plane of the wheel (that is to say a plane parallel to but not coincident with the plane of the wheel); consequently, when the undercarriage is in the deployed position, because the wheel is in the median longitudinal plane of the aircraft, the landing gear strut is offset from the aircraft axis, that is to say extends parallel to the median longitudinal plane of the aircraft but apart from (alongside) the latter;

the landing gear strut is articulated about a longitudinal axis pivot connection, i.e., the axis of which is parallel to the longitudinal axis X of the aircraft, so that the landing gear strut extends transversely when the undercarriage is in the retracted position. In other words, when the undercarriage is moved between its retracted and deployed positions (in one direction or the other) the landing gear strut moves (and remains) in a transverse plane (a plane orthogonal to the longitudinal axis X of the aircraft). Of course, when the undercarriage is in the deployed position, the landing gear strut preferably extends vertically, in the usual way.

According to one preferred feature of the invention, the landing gear bay comprises an upper wall having a plane portion forming a floor and a bowl-shaped convex portion configured to receive and to envelop the wheel closely when the undercarriage is in the retracted position. When the undercarriage is in the retracted position, it has a greater vertical dimension (dimension along the axis Z) at the level of the wheel than at the level of the deployment mechanism. While the mechanism (apart from the wheel) can be accommodated within the thickness of the main frames of the aircraft, the wheel extends in the heightwise direction beyond the internal edge of the main frames, on which internal edge of the frames the floor of the aircraft rests. The bowl shape of the upper wall of the bay at the level of the wheel enables limitation of the volume taken up by the bay above the level of the floor of the aircraft.

At the level of the front landing gear bay, the floor is eliminated and the upper wall of the bay serves as a floor. The convex portion of this upper wall, which accommodates the wheel, need not be used as a load-bearing floor. The rest of the upper wall, that is to say its plane portion, is advantageously designed to be able to support persons and/or fixtures and trolleys in order to serve as a floor.

Because of the lateral deployment (deployment in a transverse plane) of the undercarriage, the landing gear bay has a greatest dimension (length) parallel to the transverse axis Y of the aircraft. The width of the bay (dimension along the longitudinal axis X of the aircraft) substantially corresponds to the greatest width of the undercarriage, which can be the diameter of the wheel or the width of the attachment of the landing gear strut (at the level of the pivot connection).

The plane portion of the landing gear bay forming a floor is preferably flush with the level of the floor of the aircraft so as to extend in the continuity thereof.

According to a preferred feature of the invention, the plane portion of the roof of the landing gear bay forming a floor incorporates a hatch. The interior of the bay is not pressurized, whereas the exterior of the bay above its roof is in a pressurized zone inside the aircraft. A pressurized hatch is therefore advantageously provided, that is to say, a hatch that hermetically seals the upper wall of the landing gear bay and is able to withstand the pressure difference between the interior and the exterior of the aircraft on either side of the landing gear bay hatch.

The pressurized hatch is preferably provided at the level of the central axis X of the aircraft, so as to be located above the wheel when the landing gear is in the deployed position; the hatch is therefore located at the level of the median longitudinal plane of the aircraft. The hub of the wheel can then serve as a support to facilitate access to the hatch.

A first footrest is advantageously incorporated in the hub of the wheel. A second footrest can be provided on the landing gear strut. This hatch can then be used for the passage of persons, either (in one direction, to exit the aircraft) in the event of an emergency evacuation—gear down—of the aircraft or (in the other direction, that is to say, to access the interior of the aircraft) to carry out maintenance operations, for example.

Depending on the interior arrangement of the aircraft, the landing gear bay is accommodated entirely under the cockpit, or entirely under an avionics compartment, or entirely under a services zone of the cabin adjacent to the cockpit, or to an avionics compartment, that is to say, under a services zone located at the forward end of the cabin, or straddling the cockpit or the avionics compartment and the service zone of the cabin, underneath them. To summarize, the landing gear bay is preferably at least partly accommodated under the cockpit or under an avionics compartment or under a services zone situated at the forward end of the cabin.

The services zone located at the forward end of the cabin conventionally comprises a central aisle delimited by vertical structural bars and two lateral volumes dedicated to storage and service. If the landing gear bay is accommodated under this services zone, the pressurized hatch of the landing gear bay, if any, is located at the level of the central aisle, the lateral volume situated above the plane portion of the upper wall of the landing gear bay forming a floor can accommodate a large fixture (galley), that is to say a fixture occupying all of the height of the cabin, while a shorter fixture can be accommodated above the convex portion of the upper wall of the landing gear bay.

In the usual manner, the undercarriage according to the invention includes a stay rod. This stay rod is advantageously located on the side transversely opposite the wheel relative to the strut. All of the mechanism is therefore located under the wheel when the undercarriage is in the retracted position.

According to an advantageous feature of the invention, the landing gear strut incorporates a stay rod locking device.

The stay rod preferably comprises an upper arm articulated at its upper end about a longitudinal axis upper arm/bay pivot connection carried by main frames of the aircraft and a lower arm articulated at its upper end about a longitudinal axis upper arm/lower arm pivot connection carried by the lower end of the upper arm, which lower arm is also articulated at its lower end to the landing gear strut about a longitudinal axis lower arm/strut pivot connection.

The upper arm/lower arm pivot connection moves in rotation about the lower arm/strut pivot connection to go from a position, when the undercarriage is in the retracted position, in which the lower arm and the upper arm of the stay rod are one behind the other in substantially the same plane superimposed on the plane of the strut, to a position, when the undercarriage is in the deployed position, in which the lower arm of the stay rod extends against the strut, in a first plane parallel to the plane of the strut, the upper arm of the stay rod being in a second plane inclined relative to the plane of the strut.

When the undercarriage is in the retracted position, the stay rod is therefore “folded” and substantially parallel to the strut, in the vicinity of the latter, so that the mechanism has a small thickness enabling its integration within the thickness of the main frames of the aircraft. Then only the wheel necessitates adaptation of the upper wall of the landing gear bay to contain it. The invention is not limited to the mechanism described above; other mechanisms are possible, there being preferred any mechanism having a total thickness, when the undercarriage is in the retracted position, smaller than that of the main frames between which the front landing gear is accommodated.

The locking device is preferably at a distance from the lower arm/strut pivot connection substantially equal to the length of the lower arm of the stay rod so that the locking device immobilizes the upper end of the lower arm (where the upper arm/lower arm pivot connection is located) against the strut when the undercarriage is in the deployed position.

### BRIEF DESCRIPTION OF THE DRAWINGS

Other details and advantages of the present invention will become apparent on reading the following description, which refers to the appended diagrammatic drawings and relates to embodiments of the invention, which are provided by way of nonlimiting examples and can be combined. In these drawings:

FIGS. 1A to 1C relate to the prior art. FIG. 1A is a diagrammatic view in longitudinal section of an aircraft with a fuselage, FIG. 1B is a top view of this aircraft with a fuselage, and FIG. 1C is a diagrammatic view in longitudinal section of a front part of this aircraft with a fuselage.

FIG. 2A is a diagrammatic view in longitudinal section of a flying wing;

FIG. 2B is a top view of this flying wing, and FIG. 2C is a diagrammatic view in longitudinal section of a front part of this flying wing.

FIG. 3 is a diagrammatic view in front elevation of a front part of a flying wing according to the invention the skin of which has been removed to allow certain structural elements of the flying wing (main frames, vertical structural bars) to be seen together with the landing gear bay according to the invention that is represented as if transparent so as to show the undercarriage in the deployed position here.

FIG. 4 is a diagrammatic high-angle 3/4 perspective view of the flying wing part from FIG. 3 in which the undercarriage is seen in the retracted position, the bay not being shown.

FIG. 5 is a diagrammatic medium-angle 3/4 perspective view of the flying wing part from FIGS. 3 and 4 in which the landing gear bay is represented normally and the undercarriage is seen in the deployed position.

FIG. 6 is a diagrammatic high-angle back view of the flying wing part from FIGS. 3 to 5 additionally equipped with storage fixtures in its services zone.

FIG. 7 is a diagrammatic view in longitudinal section of a forward portion of a flying wing according to the invention in which are diagrammatically delimited the various functional zones of the wing (cabin, services zone, cockpit, avionics compartment, landing gear bay according to the invention).

FIG. 8 is a diagrammatic top view of the flying wing forward portion shown in FIG. 7 in which, as in FIG. 7, are diagrammatically delimited the various functional zones of the wing.

FIG. 9 is a diagrammatic front view of the flying wing forward portion shown in FIGS. 7 and 8, in which is diagrammatically represented the outline of the landing gear bay according to the invention.

FIG. 10 is a diagrammatic perspective view (from almost in front) of one embodiment of an undercarriage according to the invention, seen in the retracted position.

FIG. 11 is a diagrammatic perspective view (from almost in front) of the undercarriage from FIG. 10 seen in the deployed position.

### DETAILED DESCRIPTION OF THE PREFERRED EMBODIMENTS

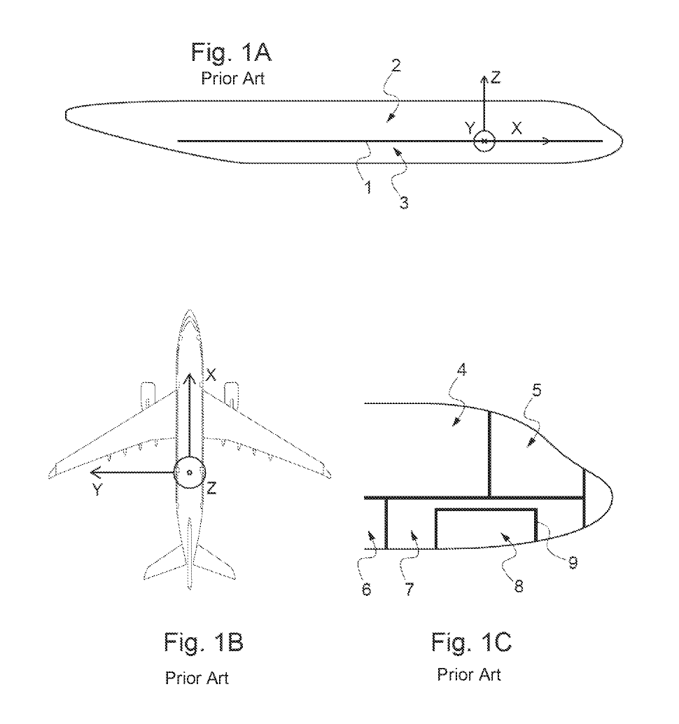

FIGS. 1A to 1C show very diagrammatically a classic passenger transport aircraft with a fuselage, such as an Airbus® A320® aircraft. Such an aircraft with a fuselage comprises a floor 1 that divides the interior volume of the aircraft into an upper zone 2 and a lower zone 3. The upper zone 2 accommodates a cockpit 5 for the crew in the nose portion of the aircraft and a cabin 4 extending aft from the cockpit 5 to a tail cone of the aircraft to receive passengers. The lower zone 3 accommodates a cargo hold 6 for receiving merchandise (including passengers' baggage) under the cabin 4, as well as a technical hold 7 under the cockpit 5 and a forward end of the cabin 4, in which technical hold are accommodated both the systems of the aircraft and the front landing gear 8, the bay of which is represented diagrammatically by a line 9. The bay 9 from FIG. 1C is a prior art substantially parallelepipedal bay. Its length (greatest dimension) follows the longitudinal direction (axis X) of the aircraft, the undercarriage being deployed in the median longitudinal plane of the aircraft about a transverse axis pivot connection.

Also shown in FIGS. 1A and 1B are the three characteristic axes X (longitudinal axis or roll axis), Y (transverse axis or pitch axis) and Z (vertical axis or yaw axis) of the aircraft.

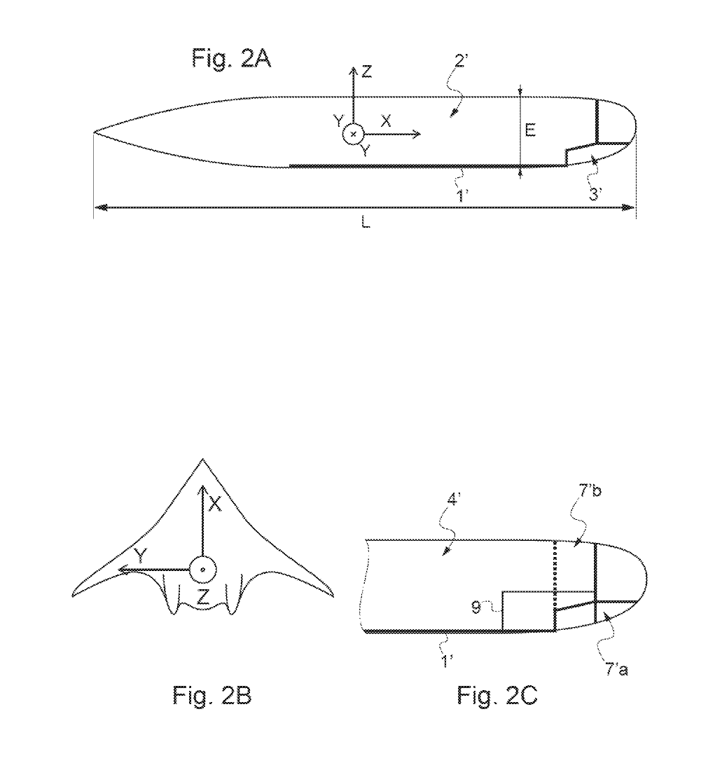

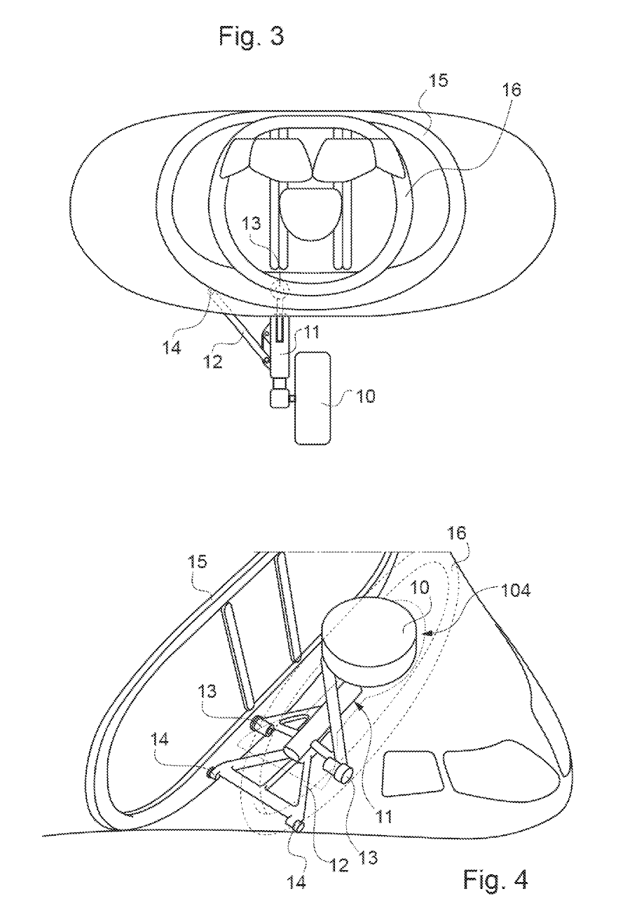

FIGS. 2A to 2C show very diagrammatically a flying wing of length L and thickness E. The flying wing comprises a low floor 1′ which nevertheless has a raised portion at the front of the flying wing in order to offer a technical hold 7a′ of reduced size (within the underfloor volume 3′) to receive systems. Over the rest of the flying wing the floor 1′ leaves only one useable volume (upper zone 2′) above it. In other words, the flying wing has no cargo hold. The upper zone 2′ accommodates a cabin 4′ and a cockpit 5′ (under which the small technical hold 7a′ is located).

Also shown in FIGS. 2A and 2B are the three characteristic axes X (longitudinal axis or roll axis), Y (transverse axis or pitch axis) and Z (vertical axis or yaw axis) of the flying wing.

If it is attempted to integrate the prior art landing gear bay 9 (that from FIG. 1C) into the flying wing from FIG. 2C, it is seen that it is much too bulky to be able to fit under the floor 1′ and that it will compete with the systems, for which the remaining volume becomes insufficient. One solution could comprise in increasing the thickness E of the flying wing in order to have a technical hold of sufficient height. This solution is not satisfactory because, for aerodynamic reasons, it is important that the ratio E/L is as small as possible. This is why the invention proposes a totally new front landing gear architecture.

As can be seen in FIGS. 3 to 11 which show an example of a front landing gear according to the invention integrated into a flying wing, the undercarriage according to the invention includes a single tire wheel 10, a landing gear strut 11, offset laterally relative to the plane of the wheel 10, and a stay rod 12.

In the deployed position, the landing gear strut 11 extends vertically (see

FIGS. 3, 5 and 11) and the wheel 10 is in the median longitudinal plane of the aircraft (the plane orthogonal to the transverse direction Y that divides the aircraft into two equal parts) with the result that the landing gear strut 11 is offset laterally to one side of the aircraft.

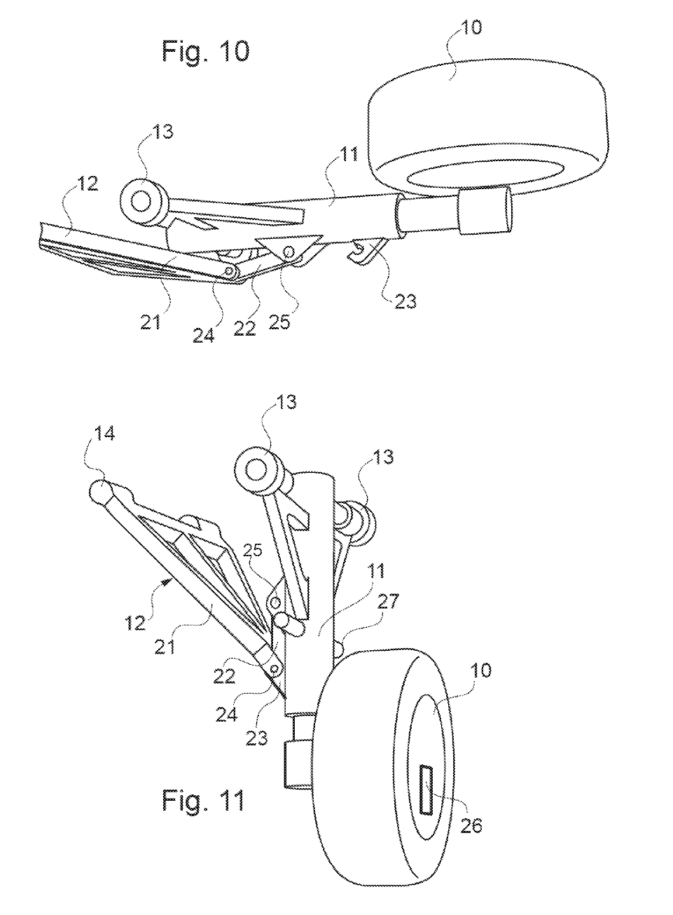

In the retracted position, the landing gear strut 11 preferably extends substantially horizontally in the transverse direction Y (see FIGS. 4 and 10).

The landing gear strut 11 is articulated at its upper end about a longitudinal axis pivot connection 13 (which pivot connection is of course fixed within the aircraft frame of reference). The pivot connection 13 is carried by two main frames 15 and 16 of the aircraft (see FIGS. 3 to 6) Similarly, the stay rod 12 is articulated at its upper end about a longitudinal axis pivot connection 14 carried by the main frames 15 and 16 of the aircraft.

The stay rod 12 comprises an upper arm 21 and a lower arm 22 (see FIGS. 10 and 11). The upper end of the upper arm 21 is articulated about the pivot connection 14. The lower end of the upper arm 21 is articulated about a longitudinal axis pivot connection 24 to the upper end of the lower arm 22. The lower end of the lower arm 22 is articulated about a longitudinal axis pivot connection 25 formed by a stirrup on the landing gear strut 11. The landing gear strut 11 further comprises a locking device 23 in the form of a hook enabling locking of the stay rod in the deployed position.

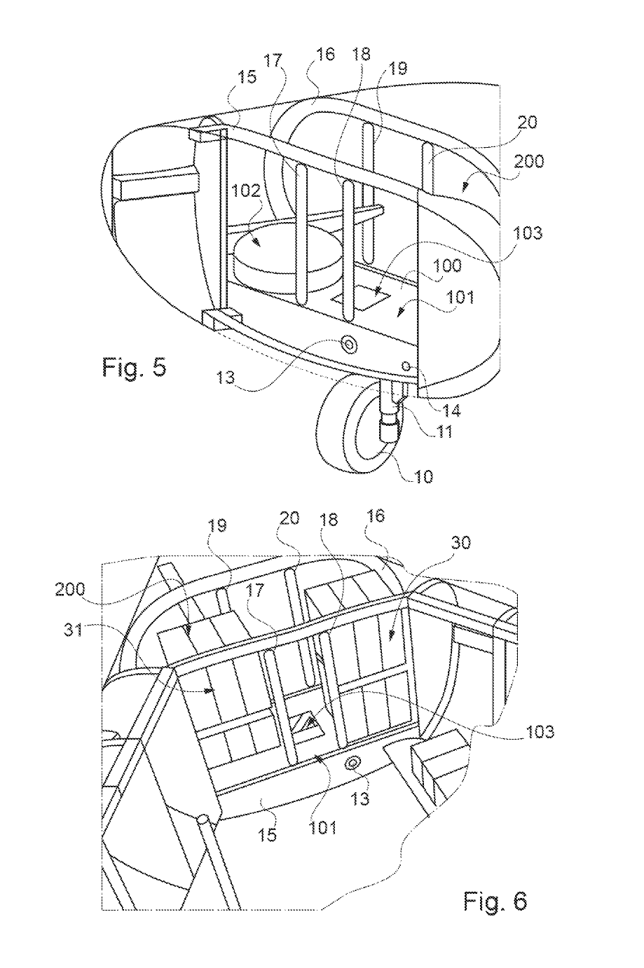

The landing gear bay 100 according to the invention, which is clearly seen in FIGS. 5 and 9, has an upper wall comprising a plane portion 101 and a bowl-shaped convex portion 102. In the retracted position, the wheel 10 of the undercarriage is accommodated under the convex portion 102, which convex portion 102 closely envelops the wheel.

In the retracted position, the landing gear strut 11 and the stay rod 12 of the undercarriage extend for the most part under the plane portion 101 of the upper wall of the landing gear bay and are accommodated within the thickness of the lower portion of the main frames.

The web of the main frame 15 forms a rear lateral wall of the landing gear bay 100 in which is located a bearing of the pivot connections 13 and 14; likewise, the web of the main frame 16 forms a front lateral wall of the landing gear bay 100 (carrying a bearing of the pivot connection 13). Finally, the landing gear bay 100 has a saucer-shaped lower wall that can be seen in FIG. 9 and comprises an opening 104 (represented in dashed line in FIG. 4) allowing the undercarriage to pass between its retracted and deployed positions.

The upper wall of the landing gear bay 100 further comprises a hatch 103 located above the wheel 10 of the undercarriage when the latter is in the deployed position. This hatch 103 is located on a central axis of the aircraft. It is sized so as to enable the passage of a person. It can be used in the event of emergency evacuation of the aircraft when the undercarriage is down (that is to say, in the deployed position) or, conversely, for access to the interior of the aircraft in the context of maintenance operations, for example.

Here a first footrest 26 and a second footrest 27 (FIG. 11) are provided on the hub of the wheel 10 and on the strut 11, respectively. The footrest 26 has a reduced depth or is pivotally mounted so as to be able to be folded parallel to the plane of the wheel, within the outline of the tire, in order not to impact on the thickness of the undercarriage when the latter is in the retracted position. For the same reason, the footrest 27 extends essentially in a longitudinal plane from the strut, its dimension in the transverse direction corresponding, for example, to the diameter of the strut.

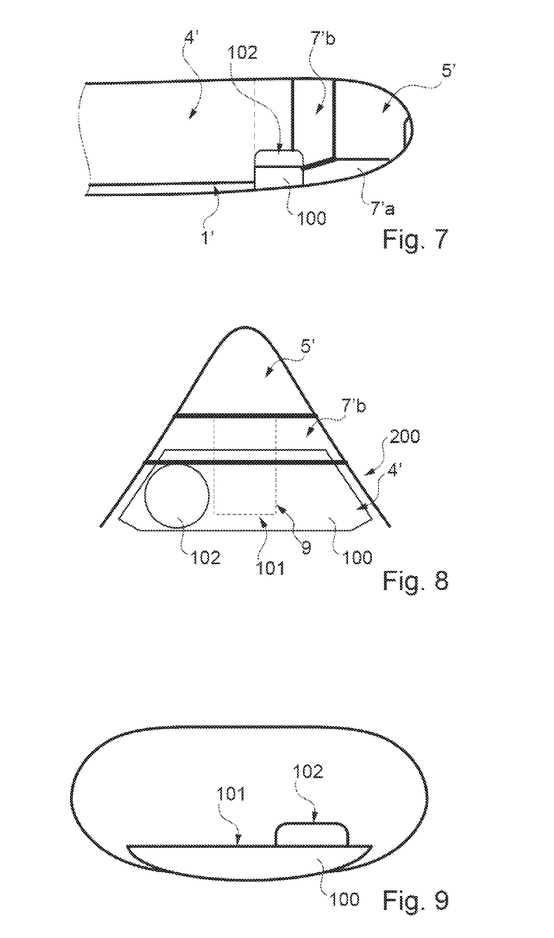

In the examples shown, immediately aft of the cockpit 5′ (see FIG. 7, which repeats FIG. 2C but with a landing gear bay 100 according to the invention) is an avionics compartment (E/E bay) 7b′ to receive systems that is extended under the cockpit by the technical hold 7′a. Aft of this avionics compartment 7b′ is the cabin 4′, separated from the avionics compartment by a vertical bulkhead.

The landing gear bay 100 is at the forward end of the cabin in a zone delimited by the main frames 15 and 16 which is reserved for services. As can be seen in FIG. 6, this services zone 200 comprises a central aisle delimited by the vertical structural bars 17 and 18 at the level of the main frame 15, and by the vertical structural bars 19 and 20 at the level of the main frame 16.

Due to the invention, storage fixtures can be arranged on either side of this central aisle, in which can be seen the pressurized hatch 103 described above. In particular, a tall galley 30 able to accommodate trolleys for serving drinks and meals can be placed in the lateral volume situated above the plane portion 101 of the upper wall of the landing gear bay 100. A shorter fixture 31 (either suspended or resting on the landing gear bay) is provided above the convex portion 102 of the upper wall of the landing gear bay. The plane portion 101 of the upper wall of the landing gear bay 100 is sized to support persons and to serve as a floor for the services zone 200 and, in particular, for the central aisle that offers access to the cockpit 5′ from the cabin 4′.

To summarize, the landing gear bay according to the invention has a small overall size along the yaw axis Z, at least over a major portion of its length along the transverse axis of the aircraft. It can therefore be accommodated in a flying wing without increasing the E/L ratio of the wing.

The invention lends itself to numerous variants, provided that they remain within the scope defined by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising a front landing gear comprising an undercarriage and a landing gear bay, the undercarriage including a single wheel and a landing gear strut, the undercarriage being movable between a retracted position in which the undercarriage is stowed inside the landing gear bay and a deployed position in which the undercarriage extends for the most part outside the landing gear bay and the aircraft, the wheel then extending in a median longitudinal plane of the aircraft, comprising:
the landing gear strut being offset laterally, extending in a plane parallel to a plane of the wheel;
the landing gear strut being articulated about a longitudinal axis pivot connection so that, when the undercarriage is moved between its retracted and deployed positions, the landing gear strut moves in a transverse plane.

2. The aircraft according to claim 1, wherein the landing gear bay comprises an upper wall having a plane portion forming a floor and a bowl-shaped convex portion configured to receive and to closely envelop the wheel when the undercarriage is in the retracted position.

3. The aircraft according to claim 1, wherein the landing gear bay has a greatest dimension in a transverse direction of the aircraft.

4. The aircraft according to claim 2, wherein the plane portion of the landing gear bay is flush with the level of a floor of the aircraft.

5. The aircraft according to claim 2, wherein the plane portion forming the floor of the upper wall of the landing gear bay incorporates a pressurized hatch.

6. The aircraft according to claim 5, wherein the pressurized hatch is provided at a level of a central axis of the aircraft so as to be located above the wheel when the undercarriage is in the deployed position.

7. The aircraft according to claim 6, wherein a first footrest is incorporated in a hub of the wheel and a second footrest is provided on the landing gear strut.

8. The aircraft according to claim 1, wherein the front landing gear is accommodated in the aircraft at least partly under at least one of a cockpit, an avionics compartment, or a services zone, located at a forward end of a cabin.

9. The aircraft according to claim 8, wherein the services zone comprises a central aisle delimited by vertical structural bars and two lateral volumes dedicated to storage and to services, and wherein a fixture having a height equivalent to an average height of the cabin is arranged in the lateral volume located above the plane portion of the upper wall of the landing gear bay, a shorter fixture being arranged above the convex portion of the upper wall of the landing gear bay.

10. The aircraft according to claim 1, wherein the undercarriage comprises a stay rod and wherein the stay rod is situated on a side transversely opposite the wheel relative to the strut.

11. The aircraft according to claim 10, wherein the landing gear strut incorporates a stay rod locking device.

12. The aircraft according to claim 10, wherein the stay rod comprises an upper arm articulated at an upper end of the upper arm about a longitudinal axis upper arm/bay pivot connection carried by main frames of the aircraft and a lower arm articulated at an upper end of the lower arm about a longitudinal axis upper arm/lower arm pivot connection carried by a lower end of the upper arm, which lower arm is also articulated at a lower end of the lower arm to the landing gear strut about a longitudinal axis lower arm/strut pivot connection.

13. The aircraft according to claim 12, wherein the landing gear strut incorporates a stay rod locking device, and wherein the upper arm/lower arm pivot connection moves in rotation about the lower arm/strut pivot connection to go from a position, when the undercarriage is in the retracted position, in which the lower arm and the upper arm of the stay rod are one behind the other in substantially the same plane superimposed on the plane of the strut, to a position, when the undercarriage is in the deployed position, in which the lower arm of the stay rod extends against the strut, in a first plane parallel to the plane of the strut, the upper arm of the stay rod being in a second plane inclined relative to the plane of the strut.

14. The aircraft according to claims 13, wherein the locking device is at a distance from the lower arm/strut pivot connection substantially equal to the length of the lower arm of the stay rod.

15. The aircraft according to claim 1, further comprising a flying wing.
